(19) United States
(12) Patent Application Publication
(10) Pub. No.: US 2005/0211023 A1
(43) Pub. Date: Sep. 29, 2005

(54) Upper edge reciprocating saw blade

(76) Inventor: Robert Steven Kalo, Novelty, OH (US)

Correspondence Address: ROBERT S. KALO, 15110 HOOK HOLLOW RD, NOVELTY, OH, 44072, US

(21) Appl. No.: 10/811,097

(22) Filed: Mar. 26, 2004

(51) Int. Cl. B23D 63/00

(52) U.S. Cl. 76/112

(57) ABSTRACT

The addition of the extra cutting edge of the new blade will allow the user to cut in all directions without the need to remove the tool from the cutting surface. It will allow cutting to the left or right, up or down and circular. It also adds an extra edge which provides additional cutting life to these disposable blades, making them cost effective as well as much more versatile.

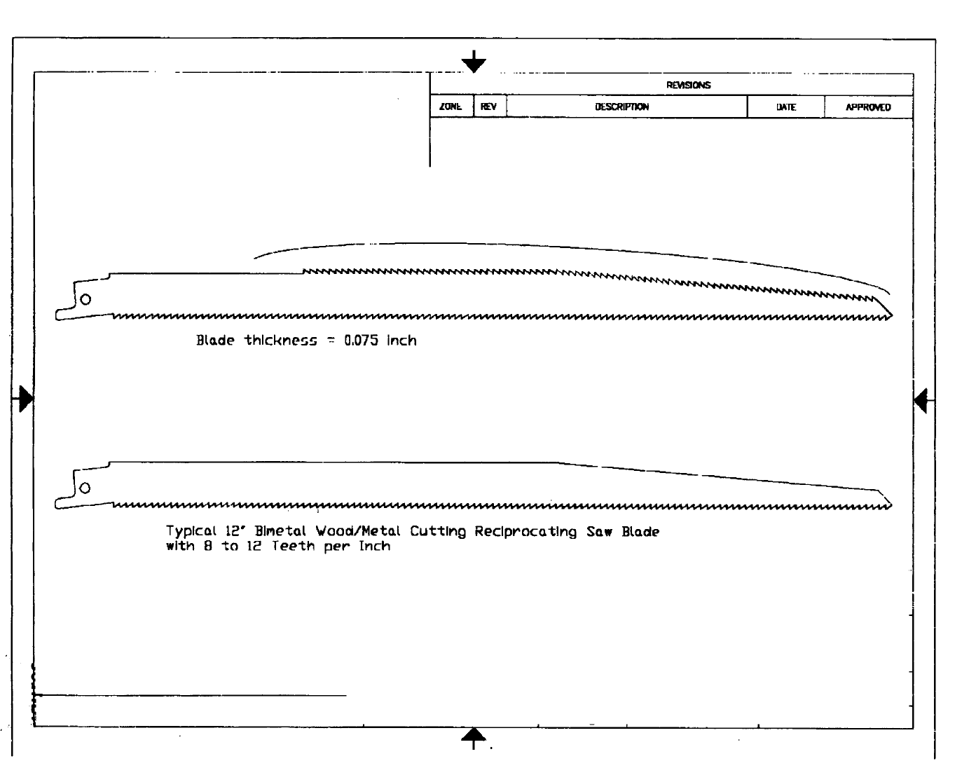

### DETAILED DESCRIPTION

Revitalization of the reciprocating saw/sawzall style blade through the addition of an extra cutting surface to the □Upper Edge□ (top side) of the blade.

This design is applicable to a variety of our wood/metal cutting bimetal blades. The number of teeth per inch varies according to the style, size and application of this product. The requirements to manufacture this particular reciprocating saw/sawzall type blade is a progressive stamping process. Starting with a knealed □1090□ carbon content steel, 00.0560 of an inch in thickness, <0.750 inches wide and 12 inches long it will be stamped on two edges (see drawing) to produce a top and bottom cutting edge. (The top edge being the revitalization of the reciprocating saw blade) with the teeth to achieve 0.0720 of an inch in thickness. My intentions are to apply this □Upper Edge□ to the wide variety of cutting blades with varying lengths, widths and teeth per inch depending on the application, i.e. wood cutting, metal cutting, also a hand held tool for cutting drywall.

1. The requirements to manufacture this particular reciprocating saw/sawzall type blade is a progressive stamping process. Starting with a knealed □1090□ carbon content steel, 00.0560 of an inch in thickness, <0.750 inches wide and 12 inches long it will be stamped on two edges (see drawing) to produce a top and bottom cutting edge. (The top edge being the revitalization of the reciprocating saw blade) with the teeth to achieve 0.0720 of an inch in thickness. My intentions are to apply this □Upper Edge□ to the wide variety of cutting blades with varying lengths, widths and teeth per inch depending on the application, i.e. wood cutting, metal cutting, also a hand held tool for cutting drywall.
